(19) United States
(12) Patent Application Publication
(10) Pub. No.: US 2008/0228842 A1
(43) Pub. Date: Sep. 18, 2008

(54) System, Method and Apparatus for Creating, Viewing, Tagging and Acting on a Collection of Multimedia Files

(76) Inventor: Sean MacGuire, Beaconsfield (CA)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/022,790

(22) Filed: Jan. 30, 2008

Related U.S. Application Data
(60) Provisional application No. 60/887,199, filed on Jan. 30, 2007.

(51) Int. Cl. G06F 17/30

(52) U.S. Cl. 707/204; 707/E17.005

(57) ABSTRACT

A multimedia archive system is disclosed along with a system, method and apparatus allowing a user to review multiple multimedia files quickly, tagging and acting on their contents as well as a means of providing feedback thereon.

### CROSS-REFERENCE TO RELATED APPLICATIONS

This application is a Nonprovisional application claiming priority to U.S. Provisional Patent Application No. 60/887,199, filed Jan. 30, 2007, which is herein incorporated by reference.

### FIELD OF THE INVENTION

The present invention relates to multimedia, and more particularly, to a system, method and apparatus for the creation of a multimedia collection, and the viewing, tagging and acting on information contained in the segments therein.

### BACKGROUND OF THE INVENTION

Andy Warhol is well known for saying that “In the future, everyone will be world-famous for 15 minutes.” http://en.wikipedia.org/wiki/15 minutes of frame. Now, with the advent of the internet and other instantaneous high-speed communications, it's more like 15 seconds of fame. Combine this with a dramatic drop in price of computer-attached cameras or webcams, and sites like YouTube®(g facilitating video interchange, broadcasting to the internet or world-wide web is becoming easy, accepted, and very popular.

It is also well known that there is more and more multimedia available for viewing, and that processing this information in the traditional manner of finding and watching is extremely time consuming. For example viewing the profiles of 100 people on a video dating service at 5 minutes each would take well over 8 hours; even longer if one needed to record their contact information. Even if one were to stop each video manually before it ended, selecting the next video, loading and playing it, is still extremely time consuming.

It is also becoming increasingly clear that people may actually be able to process information far more quickly than once thought. Nalini Ambady and Robert Rosenthal, experimental psychologists at Harvard University, analyzed the nonverbal aspects of good teaching. It appears that all the important decisions are made in the first 2 seconds. http://www.apa.org/monitor/mar05/slices.html. Thus, a system which made use of this facility to process multimedia information might likewise be far more practical than would have previously been thought.

It would be remiss to discuss such a system without express considerations about copyright. The University of Maryland University College guidelines http://www.umuc.edu/library/copy.shtml note that fair use of video would be 10% of the work or 30 seconds or less. Therefore this would suggest a clip length of 30 seconds or less for clips even though there may be other considerations to weigh.

Therefore a system which allows for the rapid review of multimedia information by chopping each file into a short segment, embedding additional information of potential interest to the user, then assembling all these pieces into a collection, and sending it to a viewer which allows the user to tag which of these segments may be of interest, along with providing a context for following up, would be a great improvement over searching through, viewing, and manually recording the desired information from each of the multimedia files alone.

Such a system could be used for dating, job interviews, finding models or actors, advertisements, studying reactions, games, viewing catalogs, etc. Therefore the need has arisen for a system, method and apparatus which provides users with the ability to create a multimedia archive with the ability to rapidly view, tag and act on information contained therein.

### SUMMARY OF THE INVENTION

According to a first aspect of the present invention, an improved method for creating a collection of multimedia files for viewing is disclosed.

According to another aspect of the invention, a method to associate additional information and available actions to with each segment of the multimedia information contained in the collection is provided.

According to a further aspect of the invention, a method for permitting the broadcaster to insert tagged and targeted advertisements into the resulting collection to generate revenue is disclosed.

A still further aspect of the invention is to provide improved methods for reviewing, selecting and acting upon a segment contained in a multimedia collection.

In addition, methods for recording feedback from a viewer about a segment contained in a multimedia collection are provided by the present invention.

### BRIEF DESCRIPTION OF THE DRAWINGS

The features of the invention will become more apparent in the following detailed description in which reference is made to the appended drawings wherein:

FIG. 1 is a block diagram of the overall system;

FIG. 2 is a sample definition of the stream as an XML file;

FIG. 3 is a schematic of the user interface for the viewer; and,

FIG. 4 is a flowchart showing how user feedback about segments is handled.

### DETAILED DESCRIPTION OF THE INVENTION

Searching for video online is a relatively new phenomenon. Internet sites such as YouTube® http://youtube.com and Google® Video http://google.com/video provide a text interface to search for videos and display the results as an link to click, possibly including an image grabbed from the video itself. In order to view these files, the user must click on the URL, which generally opens up a multimedia player associated with the type of multimedia file being accessed. The user then watches the video, if it is the one s/he is interested in. If the video is not of interest, the user must stop the currently playing video and click on the next link of interest. This is quite time-consuming, especially if there are many multimedia files to review.

The present invention creates a new multimedia archive from a list of multimedia files. This list may be as the result of a computer search as described above, or the list can be a list of multimedia files which the user would like to catalog for future reference.

A predetermined number of seconds, typically, but not restricted to, 15, depending on copyright restrictions, from each input multimedia file is appended to the archive along with additional contextual information, if available. The resulting archive is therefore a series of short clips which will allow the user to quickly review and act on a number of multimedia files far more rapidly and effectively than is now possible.

These archives may be played in a viewer which would allow the user to tag the clip for future action, as well as predetermined actions based on the additional contextual information such as viewing the entire clip, purchasing the item if it is for sale, contacting the person in the clip, etc. This viewer will generally be implemented as software, and used on a computer, or set-top box connected to a television, or telephone handset which will receive, process and display the archived contents.

Although the preferred embodiment is a computer receiving the archive streamed from a server via a high-speed internet connection, this invention could also be broadcast directly to viewing devices such as computers, televisions, cell phones and the like, using whatever interactive methods are available to the device, for example keyboards for computers, remote control devices for televisions, keypads for cellular phones, etc. Non-interactive devices may likewise view these archives, however, such devices will not get the benefits of the real-time interactivity although the user could always just take notes.

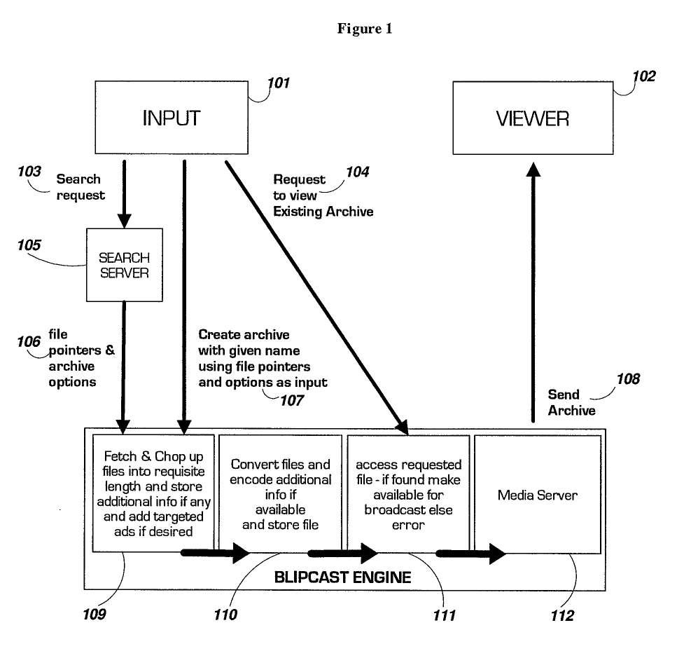

Referring therefore to FIG. 1, the system consists of an input 101, which may be a keyboard connected to a computer upon which the user enters one of three possibilities; a search request 103, a created archive with a given name using file pointers as input 107, or a request to view existing archive. Note that although the major elements are in separate boxes, they may all live on a single computer, or elements may be distributed over a high-speed network.

For a search request 103, a search term is passed to the search server 105 which may simply be a front-end to a Google® Video or YouTubeg search, or may be a custom search engine. The search request may also contain additional options, such as the requested duration of each clip, number of clips per archive, etc. The result of the search is a list of file pointers and archive options.

If the request was from either the search request 103 or a list of file pointers and archive options 107, then step 109 (fetch and chop files) receives this list of file pointers and archive options. Each multimedia file is then accessed and a predetermined number of seconds of video is collected for the archive. Based on the multimedia file itself, and where it is from, it may be possible to determine additional information of interest to the user, at minimum the location of the file the user used, plus whatever other information one can add in an automated fashion, for example an item number and URL to purchase the associated item, contact information, etc. Initially there may not be a lot of additional information available, however if this format becomes widely adopted, then this mechanism of associating additional information will become more useful as content providers begin to provide the helpful information which they want associated with their clips.

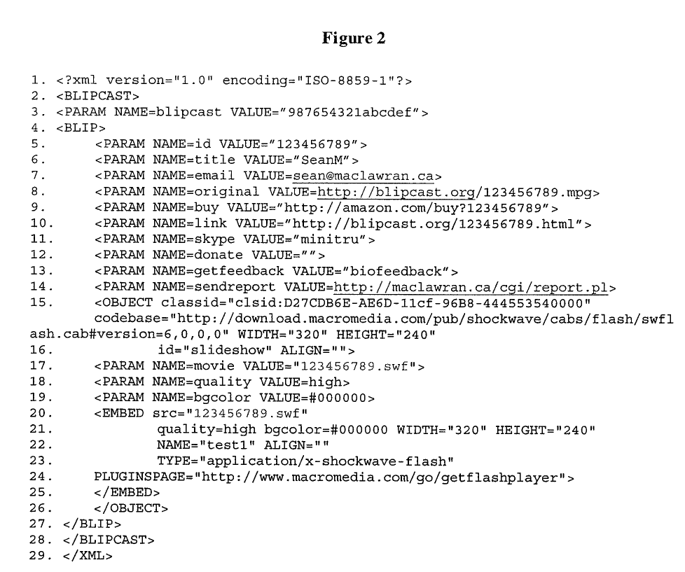

Step 110, that being converting the files and encoding additional information, if available, and storing files, receives a number of multimedia file segments along with the additional information. If necessary, the multimedia is converted to a standard format, for example Adobe Flash Video format http://en.wikipedia.org/wiki/FLV although other formats may be used if desired, and combined with the additional information collected in step 109 as an XML file, which is described in detail in FIG. 2. Conversions from one multimedia format to another are well known in the art, and the precise method of the conversions is irrelevant provided they work. In addition, advertisements may be inserted in the stream at this step to help generate revenue. These advertisements must be in the standard format and will be appended to the archive like other multimedia file inputs. This archive is then stored using the requested filename if the request originated at 107 (creating archive with given name using pointers and options as input), or is assigned a temporary file name.

Step 111 accesses the archive file created in Step 110, or searches for a previously created archive requested via step 104. If the archive is available, it is then sent to a media server 112, such as Adobe's Flash Media server http://en.wikipedia.org/wiki/Flash_Media Server, then sent to archive 108 to the viewer 102 which may be a Flash Media Player http://en.wikipedia.org/wiki/Flash_Player. If the archive cannot be found, an error message to that effect is displayed. Note that although Flash software from Adobe has been discussed, other technologies may be used if desired.

Referring now to FIG. 2, this is a description of the XML file describing the item archived. Line 1 advises this is an XML file. Lines 2 and 3 advises this is a BLIPCAST. Each blipcast will have a unique identifier associated with it. Line 4 begins a BLIP, or multimedia file segment, which likewise has a unique ID within the blipcast defined in line 5. Lines 6-14 are examples of keywords which associate the clip with additional information and actions, for example, line 7 defines an e-mail address as a contact for this blip, line 8 defines a link containing the original multimedia segment, line 9 defines a buy action where the user could click on to purchase this product from Amazon.com, line 10 is a link to more information, line 11 contains a Skype address to call, line 12 has a donate link, which is blank.

Note that the above is just a small sample, these keywords shown as name/value pairs can be defined at will, the only consideration being whether or not the viewer implements the specific actions and associations defined for each of the keywords.

The next two lines are important in that the system of the present invention has a mechanism for recording user reactions to each clip that they see. Line 13 tells us whether or not feedback is desired and using what mechanism, in this case, yes, and via biofeedback. Users wired with biofeedback mechanisms will have a measurement taken by the viewer during the clip. Other feedback mechanisms such as ‘keyboard input,’ “up/down” using the arrow keys, etc could also be defined. Similar to the situation with keywords in the XML file, feedback support will depend on the viewer being programmed to support a variety of feedback devices, and the user having said device plugged in and working during his/her viewing. Obviously if the device is not plugged in, feedback cannot be sent. Line 14 instructs where to post the results of the feedback captured.

The above has important implications in that user reactions can be automatically sent back to a collector, enabling near-real time surveys which may be almost completely unobtrusive. Using biofeedback technologies like GSR, Galvanic Skin Response, for example the GSR/Temp2X http://store.biofeedbackzone.com/gsbisy.html people's excitement when viewing different clips could be measured as described in the following article: http://www.wired.com/news/technology/0,1282,66598,00.html, incorporated herein by reference. This would be extremely useful information, especially since it could be collected automatically, and without being filtered by the users, it is likely to a more accurate representation of reality. This combined with the fact that the clips are generally quite short, means less interference from the user at the conscious level and a more accurate reaction from user viewing the clip.

Lines 15 through 26 are a standard definition for an object, and what to do with it, in this case the flash movie clip created by the process in step 110.

If there were more than one blip, it would be inserted after line 27 using the <BLIP> </BLIP> syntax. Lines 28 and 29 end this BLIPCAST, and XML respectively.

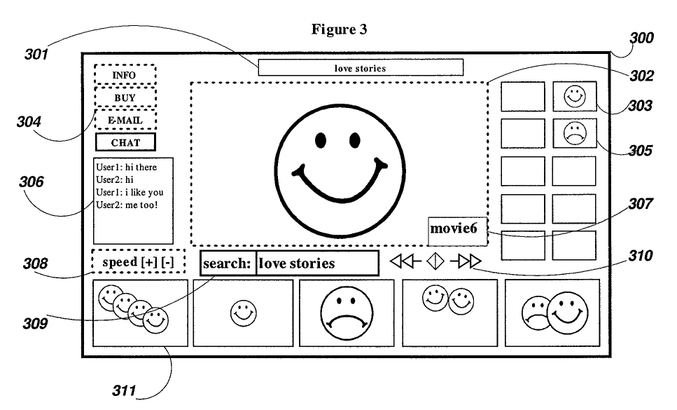

Turning now to FIG. 3, a schematic of the viewer is shown at 300. Header 301 is where text information is displayed, in this case one is viewing the results of a search for “love stories.” Main viewing window 302 is where one views the archive. If the user clicks in this area the segment is stored for later follow-up. Locations 303 and 305 are examples of what happens when one clicks on a segment for follow-up. This entire section will fill up one at a time as segments are selected for further review. The boxes at 304 represent the information in the XML which apply to the archive. In this example, the chat, email and buy buttons are enabled. A chat window is shown at 306 where User2 is chatting with User1. Panel 307 identifies what clip is being watched.

Location 308 allows one to control the playback speed; it can be increased so clips play even faster allowing the user to save even more time. Location 309 is a search box where one sees the user had been searching for “love stories.” Standard multimedia navigation buttons 310 permit one to rewind, play/stop, or fast-forward the archive.

The area represented by 311 displays frame captures of the previous clips, moving from left to right, with the most recently viewed clip at the far left. This gives the user a second chance to click on a clip even though it has already finished playing. When the user clicks on the box containing a frame capture of a clip, the clip is placed in the follow-up area denoted by 303 and 305.

Note that this is a simplified embodiment of the viewer; it would look different if implemented on a mobile phone, or TV set top box.

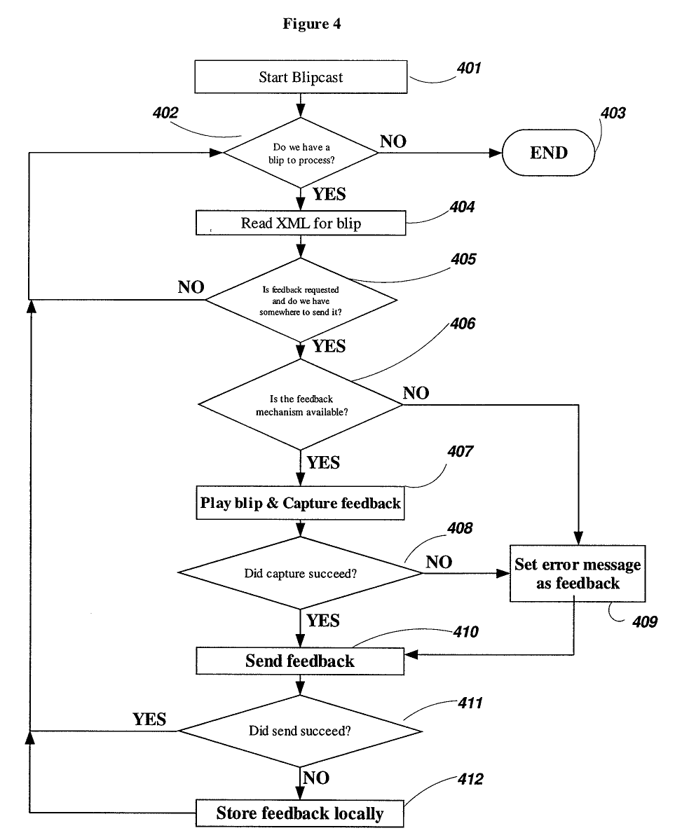

Turning now to FIG. 4, a flowchart describing the feedback mechanism is shown. When the viewer receives a blipcast and starts it 401, one checks to see if there are any multimedia segments, also known as blips, to process 402. If there aren't any, one ends 403.

If there is a blip to process, the XML related to that blip is read, checking two elements in particular. First from FIG. 2, line 13, whether feedback 405 is desired. If not, one just goes back to 402 and continues.

If one wants feedback, one now checks to see if the requested feedback mechanism, from FIG. 2, line 13, biofeedback, is available. If the feedback mechanism is empty or isn't available, the feedback is set to an error message at 409. One also checks FIG. 2, line 14 to make sure there is a place to send the results. If there is no location, then one just goes back to 402 and continues.

If it is, then one plays the blip and captures the feedback at 407. One then checks if the capture succeeded at 408. If it didn't, then the feedback is set to this error at 409.

One now sends whatever feedback obtained at 410. In general this will be a URL on a remote server equipped to handle incoming survey results. If sending the feedback is successful, one goes back to 402 and continues, otherwise one stores what feedback one received locally where it can be sent or picked up at some point in the future, and then go back to 402 to continue.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What I claim is:

1. A method for creating a collection of multimedia files on an electronic system for later viewing comprising the steps of:
a) obtaining a plurality of electronic files by doing one or more of the following steps:
conducting a computer search to generate one or more files,
requesting one or more existing, stored files, and
selecting one or more files generated by using a given name;
b) accessing each obtained file and either ensuring it is a segment of a predetermined length of time or if not, creating a segment of a predetermined length of time;
c) determining if each segment is in a standard format and either leaving it in that standard format or converting it to the standard format; and,
d) storing the standardized segments on the electronic system to create an archive of archived files.

2. The method of claim 1 further including the step of appending to each segment of step b, contextual information if available.

3. The method of claim 1 further wherein the electronic system is a computer, cell phone, or television set.

4. The method of claim 2 further including the steps of:
a) accessing the archived files;
b) sending the archived files to a media server; and,
c) reviewing the archived files on an electronic device.

5. The method of claim 4 further including the step of:
a) tagging the individual archived files for future action(s).

6. The method of claim 5 further including the step of:
a) performing at least one step from the group consisting of:
purchasing at least one entire file associated with a segment of an archived file,
viewing the entire file associate with a segment of an archived file, and
contacting an individual associated with an archived file.

7. The method of claim 6 further wherein the archived files are BLIPCAST XML files.

8. The method of claim 2 further including the step of appending to each segment of step b, advertising information if available.

9. The method of claim 4 further including the step of:
a) obtaining the reviewers reaction to each archived file reviewed; and,
b) recording the reviewers' reaction on an electronic device.

10. A method for creating a collection of multimedia files on an electronic system for later viewing comprising the steps of:
a) obtaining a plurality of electronic files by doing one or more of the following steps:
i) conducting a computer search to generate one or more files,
ii) requesting one or more existing, stored files, and
iii) selecting one or more files generated by using a given name;
b) determining if each file is in a preselected standard format and is a predetermined length of time and
i) if a file is not a predetermined length of time, creating a segment of that file of a predetermined length of time and
ii) if a file is not in a standard format, converting that file to the standard format; and,
c) storing the standardized files and segments obtained in step b on the electronic system to create an archive of archived files.
